(19) United States
(12) Patent Application Publication
(10) Pub. No.: US 2026/0170043 A1
(43) Pub. Date: Jun. 18, 2026

(54) DATA ACCESS CONTROL METHOD AND DEVICE BASED ON SEMANTIC SUPPORT, AND MEDIUM

(71) Applicant: Linyi University, Linyi (CN)

(72) Inventors: Deqian FU, Linyi (CN); Muwei JIAN, Linyi (CN)

(73) Assignee: Linyi University, Linyi (CN)

(21) Appl. No.: 19/536,951

(22) Filed: Feb. 11, 2026

Related U.S. Application Data
(63) Continuation of application No. PCT/CN2024/129883, filed on Nov. 5, 2024.

(30) Foreign Application Priority Data
Nov. 9, 2023 (CN) 202311492798.1

(51) Int. Cl. G06F 16/36

(52) U.S. Cl. CPC G06F 16/367

(57) ABSTRACT

A data access control method, device and medium based on semantic support. The method comprises: establishing an ontology model of data semantics by a data provider based on an ontology knowledge of each distributed data source data, and uploading the ontology model to a blockchain network; rule information is provided for the data source data, and a distributed data source data address is provided for writing the rule information into a smart contract of the blockchain network. The rule information is used to represent an access control policy, wherein data access requests are uploaded through the blockchain network, and authorization information for the data access request is acquired from rule information in the smart contract. If it is determined that the authorization information permits access, encrypted fine-grained data corresponding to the data access request is sent to a data access end.

This application is based upon and claims priority to Chinese Patent Application No. 202311492798.1, filed on Nov. 9, 2023, with the title “a data access control method and device based on semantic support, and medium,” the entire contents of which are incorporated herein by reference.

### TECHNICAL FIELD

The present disclosure relates the field of data access control, particularly a data access control method and device based on semantic support, and a medium.

### BACKGROUND

Access control is a critical technology for ensuring data security, which grants a subject the right to access an object based on predefined access authorization policies and manages the process of the subject's permissions, thereby enabling authorized access to system resources. The primary function of conventional access control models is to address data access authorization issues, prevent unauthorized access by illegitimate users and unauthorized actions by legitimate users, and ensure that data access occurs only within a secure and controllable environment under authorization. Due to its flexibility and applicability, the current attribute-based access control method has been widely used in open and distributed systems.

Nevertheless, as the scale and complexity of systems increase, the number of attributes and policies involved also grows, leading to increased complexity in policy management when using attribute-based access control for data access control. The system is required to process a large volume of attributes and rules, which raises the difficulty of policy maintenance. Moreover, due to a lack of consideration for the semantic features of the data itself, the accuracy of access control is relatively low. Additionally, when using, different departments, applications, or services, they may define distinct policies for the same data, resulting in inconsistent access control behavior and making it difficult to maintain policy uniformity.

### SUMMARY

In order to solve the above technical problems, one or more embodiments of the present disclosure provide a data access control method and device based on semantic support, and a medium.

One or more embodiments of the present disclosure adopt the following technical solutions:

One or more embodiments of the present disclosure provide a data access control method based on semantic support, the method includes:
establishing an ontology model of data semantics by a data provider based on an ontology knowledge of each distributed data source data, and uploading the ontology model to a blockchain network;
providing rule information for the data source data by the data provider, and writing a distributed data source data address and the rule information into a smart contract of the blockchain network; wherein the rule information is used to represent an access control policy for the distributed data source data;
receiving a data access request uploaded by a data access end through the blockchain network at the data provider, and acquiring authorization information for the data access request from rule information in the smart contract;
if the data provider determines that the authorization information permits access, acquiring fine-grained data corresponding to the data access request based on the data access mode of the ontology model, encrypting the fine-grained data, and sending the encrypted fine-grained data to the data access end.

Optionally, in one or more embodiments of the present disclosure, establishing the ontology model of data semantics by the data provider based on the ontology knowledge of each distributed data source data, and uploading the ontology model to the blockchain network, specifically including:
acquiring ontology elements of each distributed data source data; wherein the ontology elements include: an access control concept, an access control rule, and a data source mapping rule;
determining a relationship between attributes of each distributed data source data and each distributed data source data based on an application scenario corresponding to each distributed data source data;
performing a reasoning verification on the ontology elements, the attributes, and the relationship based on a preset ontology reasoning method, and determining ontology knowledge of each distributed data source data if the verification is passed; wherein the preset ontology reasoning method is defined based on ontology reasoning rules in a blockchain network rule base;
standardizing the ontology knowledge according to a preset ontology modeling language to obtain an ontology model of data semantics; wherein the preset ontology modeling language includes: a web ontology language (OWL) and a resource description framework (RDF);
uploading the ontology model to the blockchain network, thereby enabling an update of a public knowledge ontology library within the blockchain network.

Optionally, in one or more embodiments of the present disclosure, before uploading the ontology model to the blockchain network, the method further includes:
sending authentication information to the blockchain network by the data provider; wherein the authentication information includes: a data provider identifier and a data provider identity certificate;
performing an identity authentication on the data provider by the blockchain network based on the data provider identity certificate, and obtaining an authentication result;
receiving the authentication result by the data provider to determine whether to upload the ontology model to the blockchain network based on the authentication result.

Optionally, in one or more embodiments of the present disclosure, providing rule information for the data source data by the data provider, and writing the distributed data source data address and the rule information into the smart contract of the blockchain network, specifically including:
determining an access right of the ontology model by the data provider based on a resource type corresponding to the ontology model;
establishing a rule logic of access conditions and access results corresponding to the ontology model based on the access right;
defining the rule logic based on a preset semantic rule language, providing rule information of the data source data, and writing the distributed data source data address and corresponding rule information into the smart contract of the blockchain network; wherein the preset semantic rule language is a semantic web rule language (SWRL).

Optionally, in one or more embodiments of the present disclosure, before receiving the data access request uploaded by the data access end through the blockchain network at the data provider, the method further includes:
sending authentication information to the blockchain network by the data access end; wherein the authentication information includes: a data access end identifier and a data access end identity certificate;
performing an identity authentication on the data access end by the blockchain network based on the data access end identity certificate, and obtaining an authentication result;
if it is determined that the authentication is passed, sending a data access request uploaded by the data access end to the data provider through the blockchain network.

Optionally, in one or more embodiments of the present disclosure, acquiring authorization information for the data access request from rule information in the smart contract, specifically includes:
acquiring attribute information in the data access request by the blockchain network; wherein the attribute information includes: identity information, request resource information, and timestamp information of the data access end;
traversing the rule information in a common knowledge ontology library by the blockchain network, and acquiring rule information matching the attribute information;
determining whether the attribute information satisfies an access condition in the matching rule information by the blockchain network, so as to return the authorization information of the data access request to the data provider.

Optionally, in one or more embodiments of the present disclosure, before acquiring fine-grained data corresponding to the data access request based on the data access mode of the ontology model, the method further includes:
based on the ontology model, performing a data structure conversion on each distributed data source data to obtain standard distributed data source data;
determining a neighborhood concept and an inter-concept relationship of the standard distributed data source data based on the ontology model, so as to determine a mapping rule of the standard distributed data source based on the neighborhood concept and the inter-concept relationship;
mapping the standard distributed data source and ontology knowledge of the standard distributed data source based on the mapping rule, so as to integrate each distributed data source data to obtain a virtual knowledge graph.

Optionally, in one or more embodiments of the present disclosure, acquiring fine-grained data corresponding to the data access request based on the data access mode of the ontology model, encrypting the fine-grained data, and sending the encrypted fine-grained data to the data access end, specifically including:
generating a query instruction corresponding to the data access request based on a preset query language;
calling a query interface of the virtual knowledge graph to send the query instruction to the virtual knowledge graph based on the query interface, acquiring data corresponding to the data access request based on the mapping of the virtual knowledge graph, and summarizing and generating fine-grained data;
encrypting the fine-grained data based on a preset encryption method, so as to send the encrypted fine-grained data to the data access end based on the blockchain network.

One or more embodiments of the present disclosure provide a data access control device based on semantic support, including: a memory for storing computer program instructions and a processor for executing the program instructions, wherein when the computer program instructions are executed by the processor, the device is triggered to perform any of the above-described methods.

One or more embodiments of the present disclosure provide a non-volatile computer storage medium, stores computer-executable instructions, and the computer-executable instructions are configured to perform any of the above-described methods.

The embodiments of the present disclosure adopt at least one of the aforementioned technical solutions, which are capable of achieving the following beneficial effects:

The ontology model of data semantics is established based on the ontology knowledge of each data in each distributed data source, and access rules are defined based on the ontology. This method avoids the ambiguity issues inherent in conventional access methods, enabling the call access process to be more reliable and accurate. The established ontology model is uploaded to the blockchain, enabling the smart contract to be defined and loaded it to the blockchain according to the rule information of the data source data. This facilitates policy management and maintenance, and makes the access control policy more flexible and extensible. Utilizing the data access method corresponding to the ontology model, the fine-grained data query based on semantic support is realized, achieving unified access to data across different data sources. Furthermore, the distributed query process based on blockchain enables efficient processing of large-scale datasets and access requests.

### BRIEF DESCRIPTION OF THE DRAWINGS

To explain the embodiments of the present disclosure or the technical solutions in the prior art more clearly, a brief introduction will be made to the accompanying drawings used in the embodiments or the description of the prior art. It is obvious that the drawings in the description below are only some embodiments of the present disclosure, and those ordinarily skilled in the art can obtain other drawings according to these drawings without creative work. In the drawings:

FIG. 1 is a schematic flow diagram of a data access control method based on semantic support according to an embodiment of the present disclosure;

FIG. 2 is a schematic diagram of an update flow of ontology knowledge according to an embodiment of the present disclosure;

FIG. 3 is a schematic diagram of an internal structure of a data access control device based on semantic support according to an embodiment of the present disclosure;

FIG. 4 is a schematic diagram of an internal structure of a non-volatile storage medium according to an embodiment of the present disclosure.

### DETAILED DESCRIPTION OF THE EMBODIMENTS

The embodiment of the present disclosure provides a data access control method and device based on semantic support, and a medium.

In order to make the personnel in the technical field better understand the scheme of the present disclosure, the following will describe the technical scheme in the embodiment of the invention clearly and completely in combination with the accompanying drawings. Apparently, the described embodiments are only some but not all of the embodiments of the present disclosure. All other embodiments obtained by those of ordinary skill in the art based on the embodiments of the present disclosure without involving any creative effort shall fall within the scope of protection of the present disclosure.

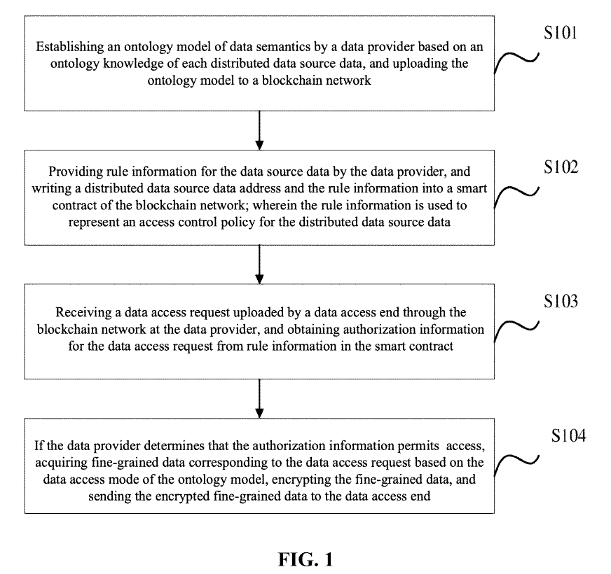

As shown in FIG. 1, one or more embodiments of the present disclosure provide a data access control method based on semantic support, the method specifically includes the following steps:

S101: the ontology model of data semantics is established by the data provider based on the ontology knowledge of each distributed data source data, and the ontology model is uploaded to the blockchain network.

In order to facilitate semantic reasoning support, realize semantically-supported data access control, improve the accuracy and reliability of access control, and avoid the ambiguity that may exist in conventional access control systems, in the embodiments of the present disclosure, the data provider, i.e., the data owner establishes an ontology model of data semantics based on the ontological knowledge of each distributed data source data, and uploads the established ontology model to the blockchain. This enables subsequent distributed processing of large-scale datasets and access requests based on the ontology model on the blockchain. By loading the ontology model to the blockchain, the distributed advantages of blockchain are fully leveraged, thereby enhancing the scalability and reliability of data access control.

Specifically, in one or more embodiments of the present disclosure, establishing the ontology model of data semantics by the data provider based on the ontology knowledge of each distributed data source data, and uploading the ontology model to the blockchain network, specifically including:

firstly, ontology elements of each distributed data source data are acquired. It should be noted that the ontology elements include the access control concept, the access control rule, and the data source mapping rule. Secondly, the relationship between attributes of each distributed data source data and each distributed data source data is determined based on the application scenario corresponding to each distributed data source data. Thirdly, the reasoning verification is performed on the ontology elements, the attributes, and the relationships based on the preset ontology reasoning method, and the ontology knowledge of the distributed data source data is determined if the verification is passed. It should be noted that the preset ontology reasoning method is defined based on ontology reasoning rules in the blockchain network rule base. After acquiring ontology knowledge, the ontology knowledge is standardized according to the preset ontology modeling language to obtain the ontology model of data semantics. It should be noted that the preset ontology modeling language includes OWL and RDF. Subsequently, the ontology model is uploaded to the blockchain network, thereby enabling an update of the public knowledge ontology library within the blockchain network. It should be further noted that ontology knowledge construction is an iterative process. In practical applications, multiple revisions and refinements are required based on actual conditions. Moreover, the process of ontology modeling construction can utilize ontology editing tools, such as Protégé, to assist in the creation and management of ontologies.

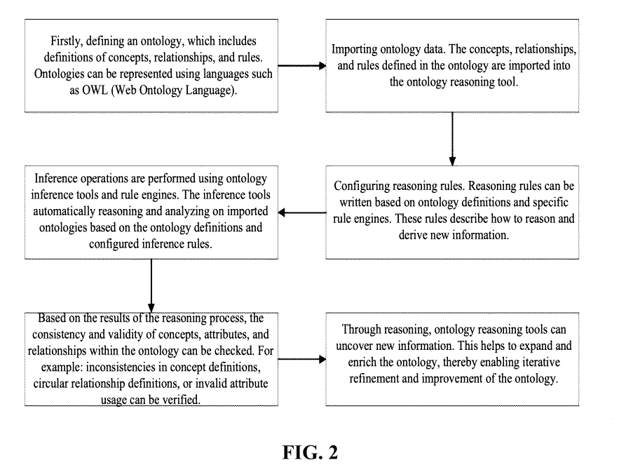

It should be noted that the ontology is a formalized method for knowledge representation. By defining entity attributes and relationships, it can describe the semantic information of data and the meaning of access policies. In the embodiments of the present disclosure, firstly, ontology knowledge is employed to model data semantics, thereby defining the structure, attributes, and relationships of data as ontology concepts, attributes, and relationships. This enables a more accurate expression of the data's meaning and semantic relationships. Concurrently, access rights and policies are also represented as ontology concepts and attributes, which include user roles, access conditions, and operation permissions. This facilitates precise access control by allowing comparisons and reasoning between the contextual information of a request and the data and permissions defined within the ontology model during data requests. As shown in FIG. 2, for a specific application scenario of the present disclosure, the data provider acquires ontology knowledge of data from each distributed data sources through the following process: firstly, ontology elements are determined, that is, the elements and scope of the ontology are clarified, and the access control concepts, access control rules, and data source mapping rules that need to be represented and described are defined. Then, their attributes and rules are defined, that is, based on the actual application scenario, attributes and relationships are defined for each entity. It should be understood that: entities refer to subjects, resources, and other elements relevant to access control. Attributes describe the features, attributes, or states of entities, including object attributes and data attributes. Object attributes describe relationships between entities. They are typically used to represent complex inter-entity relationships, such as hierarchical, associative, or compositional relationships. For example, “parent” is an object attribute that associates a person entity with its parent entity. Data attributes describe the features or attribute values of entities, typically representing specific attributes or features of entities. The values of the data attributes can be of a specific data type, such as string, numeric, or date. For example, defining user attributes, such as username, department, role, and resource attributes, such as name, and type. Concurrently, the relationships between attributes and entities are defined, such as which attributes a user possesses or which attributes characterize a resource. A relationship may be a one-to-one, one-to-many, or many-to-many association relationship.

Further, to ensure the reliability and security of data access, in one or more embodiments of the present disclosure, before uploading the ontology model to the blockchain network, the method further includes:
the authentication information is sent to the blockchain network by the data provider. It should be noted that the authentication information includes the data provider identifier and the data provider identity certificate. Then, the identity authentication is performed on the data provider by the blockchain network based on the data provider identity certificate, and the authentication result is obtained. Subsequently, the authentication result is received by the data provider to determine whether to upload the ontology model to the blockchain network based on the authentication result, thereby enabling subsequent distributed automated access processes based on the blockchain. By requiring data provider to provide authentication information, the blockchain network can verify the authenticity and legitimacy of the data provider. This method effectively prevents unauthorized or malicious entities from uploading data to the blockchain, thereby ensuring the overall security of data within the blockchain network.

S102: the rule information for the data source data is provided by the data provider, and the distributed data source data address and the rule information are written into the smart contract of the blockchain network; wherein the rule information is used to represent the access control policy for the distributed data source data.

Most existing access control systems are centralized, which makes it difficult for data providers to scale when handling large-scale datasets and access requests, consequently resulting in low processing efficiency. In conventional distributed environments, as system scale and complexity grow, attribute-based access control methods face challenges due to a corresponding increase in the number of involved attributes and policies. This complicates policy management because systems need to handle large volumes of attributes and rules, increasing maintenance difficulty. Furthermore, different departments, applications, or services may define varying policies for the same data during use, leading to inconsistent access control behaviors. That is, for large-scale datasets and access requests, data distribution across different data sources or services, coupled with differing data definitions and access policies among them and the absence of a unified standard, makes the policy management and maintenance process even more challenging. Therefore, to facilitate the management of access control policies, the data provider in the embodiments of the present disclosure provides the rule language of the data source data, thereby writing the distributed data source data address and the rule information into the smart contract on the blockchain network. It should be noted that this rule information is used to represent the access control policy for each data within the distributed data source.

Specifically, in one or more embodiments of the present disclosure, providing rule information for the data source data by the data provider, and writing the distributed data source data address and the rule information into the smart contract of the blockchain network, specifically including:

Firstly, the access right of the ontology model is determined by the data provider based on the resource type corresponding to the ontology model. That is, the first step is to determine what resource data in the data provider needs protection, as well as the permission types and operation types associated with each resource type. For example, Resource A may necessitate administrator-level access rights, whereas Resource B may only require ordinary user-level access rights. Then, the rule logic of access conditions and access results corresponding to the ontology model is established based on the determined access right. Subsequently, the rule logic is defined based on the preset semantic rule language, the rule information of the data source data is provided, and the distributed data source data address and corresponding rule information are written into the smart contract of the blockchain network. It should be noted that the preset semantic rule language is SWRL. The SWRL rule consists of an antecedent and a consequent, describing access conditions and results through logical relationships. The antecedent of the SWRL rule defines the conditions of an access request, which may include user identity, roles, attributes, and other contextual information. For example, a prerequisite could be that a specific user belongs to a specific role or that the requested time falls within a specified range. The result of an access request is defined in the consequent of the SWRL rule. This result can be authorized access, denied access, or other related actions or prompts. For example, the conclusion can be the result of authorizing access or denying access.

S103: the data access request uploaded by the data access end through the blockchain network is received at the data provider, and authorization information for the data access request from rule information in the smart contract is acquired.

Based on the aforementioned step S102, the data access policy and relevant data information are written into the smart contract and deployed onto the blockchain. Subsequently, in the present disclosure, the data provider in real time can receive a data access request uploaded by the data access end based on the blockchain network, and acquire authorization information for the data access request from the rule language within the smart contract, thereby achieving a distributed automatic access decision. Through the rule language within the smart contract, data access requests are processed automatically without manual intervention, which significantly enhances the efficiency and automation level of data access.

Further, to ensure the legitimacy of the data access end and enhance the reliability and security of data access. In one or more embodiments of the present disclosure, before receiving the data access request uploaded by the data access end through the blockchain network at the data provider, the method further includes the following process to achieve authentication of the data access end:

Firstly, the authentication information is sent to the blockchain network by the data access end. It should be noted that the authentication information includes the data access end identifier and the data access end identity certificate. Then, the identity authentication is performed on the data access end by the blockchain network based on the data access end identity certificate, and the authentication result of the data access end is obtained. If it is determined that the authentication is passed, the data access request uploaded by the data access end is sent to the data provider through the blockchain network.

Specifically, in one or more embodiments of the present disclosure, acquiring authorization information for the data access request from rule information in the smart contract, specifically includes: the attribute information in the data access request is acquired by the blockchain network. It should be noted that the attribute information includes identity information, request resource information, and timestamp information of the data access end. Then, the rule information is traversed in the common knowledge ontology library by the blockchain network, and the rule information matching the attribute information is acquired. Subsequently, whether the attribute information satisfies an access condition in the matching rule information is determined by the blockchain network, so as to return the authorization information of the data access request to the data provider.

That is, within the application scenario of the present disclosure, the blockchain utilizes smart contracts to authorize data access requests from data access ends. According to the knowledge stored in the smart contract's rule base, it performs rule matching against the attribute information contained in the data access requests from the data access end. This attribute information in the access requests may include the identity information, request resource information, and timestamp information of the data access end, and the attribute information is used to determine the subsequent access rights. Based on the attribute information within the access request, an inference engine is employed for analysis and processing. When using the inference engine for processing, the inference engine first loads the ontology knowledge defined in step S101 above. Then, upon receiving an access request, the inference engine automatically traverses the rule files in the rule base to locate rules matching the current access request. The inference engine checks whether the access request's attribute information satisfies the rule's preconditions, and accordingly returns authorization information. This authorization information, which includes access rights or denial of access rights, is then stored on the blockchain.

S104: if the data provider determines that the authorization information permits access, fine-grained data corresponding to the data access request is acquired based on the data access mode of the ontology model, the fine-grained data is encrypted, and sent to the data access end.

Based on the determination of authorization information according to step S103 above, if the data provider determines that the authorization information determined by the blockchain network permits access, then the data provider can acquire the fine-grained data corresponding to the data access request. This acquisition is performed according to the data access method corresponding to the ontology model defined in the blockchain network in step S101. Subsequently, the acquired fine-grained data is encrypted and sent to the data access end, thereby realizing the distributed automatic access process.

Further, to achieve finer partitioning and classification of the data, thereby providing more specific and detailed information, fine-grained data management is achieved. In one or more embodiments of the present disclosure, before acquiring fine-grained data corresponding to the data access request based on the data access mode of the ontology model, the method further includes:

Firstly, based on the ontology model, the data structure conversion is performed on each distributed data source data to obtain standard distributed data source data, thereby achieving data consistency. Then, the neighborhood concept and the inter-concept relationship of the standard distributed data source data are determined based on the ontology model, so as to determine the mapping rule of the standard distributed data source based on the neighborhood concept and the inter-concept relationship. The standard distributed data source and ontology knowledge of the standard distributed data source are mapped based on the mapping rule, so as to integrate the each distributed data source data to obtain the virtual knowledge graph. During the integration process of the aforementioned distributed data sources, ontology-based data access (OBDA) technology is employed to integrate the data from the distributed data sources into a virtual knowledge graph. This achieves unified querying and access, enabling users to utilize the same query language and query interface to query and analyze the entire virtual knowledge graph, thereby simplifying access to and operations on distributed data sources. It should be noted that OBDA includes three components: ontology, data source, and mapping. Compared to conventional information management systems, OBDA provides users not only with a simplified data structure but also with richly semantic descriptions. It expresses the neighborhood concepts involved in the data sources and the relationships between these concepts through ontology, providing a unified conceptual view for the information that requires management.

Specifically, in one or more embodiments of the present disclosure, acquiring fine-grained data corresponding to the data access request based on the data access mode of the ontology model, encrypting the fine-grained data, and sending the encrypted fine-grained data to the data access end, specifically including:

Firstly, the query instruction corresponding to the data access request is generated based on the preset query language SPARQL. Then, the query interface of the virtual knowledge graph is called to send the query instruction to the virtual knowledge graph based on the query interface, the data corresponding to the data access request is acquired based on the mapping of the virtual knowledge graph, and the fine-grained data is summarized and generated. It should be noted that SPARQL is a query language designed for querying RDF data. By employing the SPARQL query language, queries can be sent directly to the virtual knowledge graph to acquire data that meets specific conditions. SPARQL queries can include operations such as pattern matching, attribute filtering, and relationship querying, thereby enabling fine-grained data query and analysis. After obtaining the fine-grained data, to enhance data transmission security, in the embodiment of the present disclosure, the data provider encrypts the fine-grained data acquired through the query based on the preset encryption method, so as to send the encrypted fine-grained data to the data access end based on the blockchain network.

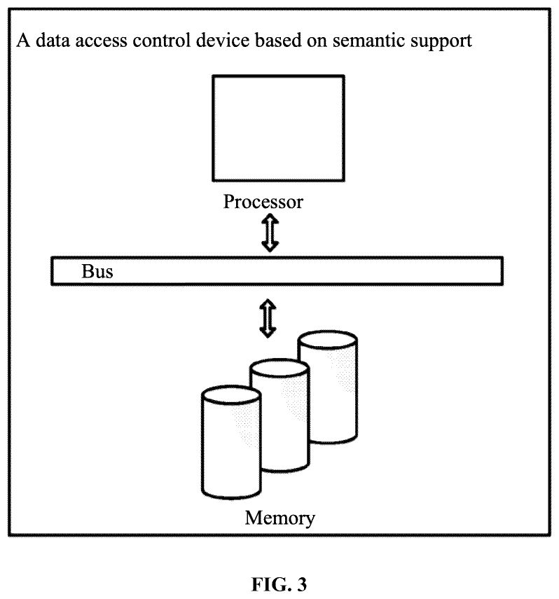

As shown in FIG. 3, the schematic diagram of the internal structure of the data access control device based on semantic support is provided in the embodiment of the present disclosure. As can be seen from FIG. 3, the device includes: a memory for storing computer program instructions and a processor for executing the program instructions, wherein when the computer program instructions are executed by the processor, the device is triggered to perform any of the above-described methods.

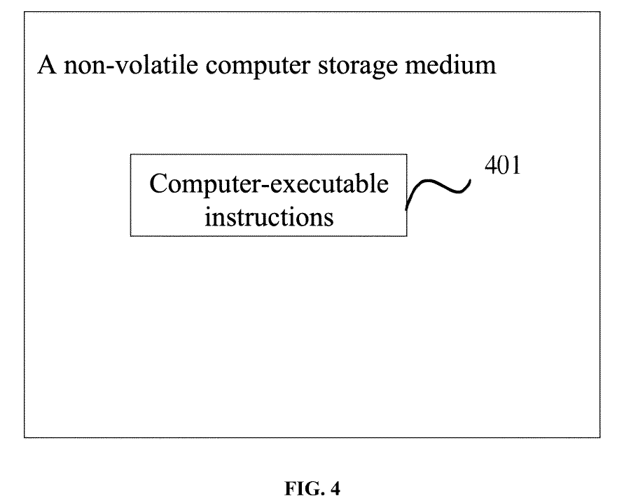

As shown in FIG. 4, the schematic diagram of the internal structure of the non-volatile storage medium is provided in embodiment of the present disclosure. As can be seen from FIG. 4, in one or more embodiments of the present disclosure, the non-volatile storage medium stores computer-executable instructions 401. The computer-executable instructions 401 are capable of: performing any of the above-described methods.

The technical solutions protected by the present disclosure are not limited to the above embodiments. It should be noted that any combination of technical solutions from one embodiment with those from one or more other embodiments falls within the scope of protection of this application. Although the present disclosure has been described in detail above with reference to general descriptions and specific embodiments, modifications or improvements may be made based on the present disclosure, which are apparent to those skilled in the art. Therefore, such modifications or improvements made without departing from the spirit of the present disclosure are all within the scope of protection claimed herein.

What is claimed is:

1. A data access control method based on semantic support, wherein the method comprises:
establishing an ontology model of data semantics by a data provider based on an ontology knowledge of each distributed data source data, and uploading the ontology model to a blockchain network;
providing rule information for the data source data by the data provider, and writing a distributed data source data address and the rule information into a smart contract of the blockchain network; wherein the rule information is used to represent an access control policy for the distributed data source data;
receiving a data access request uploaded by a data access end through the blockchain network at the data provider, and acquiring authorization information for the data access request from rule information in the smart contract; and
if the data provider determines that the authorization information permits access, acquiring fine-grained data corresponding to the data access request based on the data access mode of the ontology model, encrypting the fine-grained data, and sending the encrypted fine-grained data to the data access end.

2. The data access control method based on semantic support according to claim 1, wherein establishing the ontology model of data semantics by the data provider based on the ontology knowledge of each distributed data source data, and uploading the ontology model to the blockchain network, specifically comprises:
acquiring ontology elements of each distributed data source data; wherein the ontology elements comprise: an access control concept, an access control rule, and a data source mapping rule;
determining a relationship between attributes of each distributed data source data and each distributed data source data based on an application scenario corresponding to each distributed data source data;
performing a reasoning verification on the ontology elements, the attributes, and the relationship based on a preset ontology reasoning method, and determining ontology knowledge of each distributed data source data if the verification is passed; wherein the preset ontology reasoning method is defined based on ontology reasoning rules in a blockchain network rule base;
standardizing the ontology knowledge according to a preset ontology modeling language to obtain an ontology model of data semantics; wherein the preset ontology modeling language comprises: a web ontology language (OWL) and a resource description framework (RDF); and
uploading the ontology model to the blockchain network, thereby enabling an update of a public knowledge ontology library within the blockchain network.

3. The data access control method based on semantic support according to claim 1, wherein before uploading the ontology model to the blockchain network, the method further comprises:
sending authentication information to the blockchain network by the data provider; wherein the authentication information comprises: a data provider identifier and a data provider identity certificate;
performing an identity authentication on the data provider by the blockchain network based on the data provider identity certificate, and obtaining an authentication result; and
receiving the authentication result by the data provider to determine whether to upload the ontology model to the blockchain network based on the authentication result.

4. The data access control method based on semantic support according to claim 1, wherein providing rule information for the data source data by the data provider, and writing the distributed data source data address and the rule information into the smart contract of the blockchain network, specifically comprises:
determining an access right of the ontology model by the data provider based on a resource type corresponding to the ontology model;
establishing a rule logic of access conditions and access results corresponding to the ontology model based on the access right; and
defining the rule logic based on a preset semantic rule language, providing rule information of the data source data, and writing the distributed data source data address and corresponding rule information into the smart contract of the blockchain network; wherein the preset semantic rule language is a semantic web rule language (SWRL).

5. The data access control method based on semantic support according to claim 1, wherein before receiving the data access request uploaded by the data access end through the blockchain network at the data provider, the method further comprises:
sending authentication information to the blockchain network by the data access end; wherein the authentication information comprises: a data access end identifier and a data access end identity certificate;
performing an identity authentication on the data access end by the blockchain network based on the data access end identity certificate, and obtaining an authentication result; and
if it is determined that the authentication is passed, sending a data access request uploaded by the data access end to the data provider through the blockchain network.

6. The data access control method based on semantic support according to claim 2, wherein acquiring authorization information for the data access request from rule information in the smart contract, specifically comprises:
acquiring attribute information in the data access request by the blockchain network; wherein the attribute information comprises: identity information, request resource information, and timestamp information of the data access end;
traversing the rule information in a common knowledge ontology library by the blockchain network, and acquiring rule information matching the attribute information; and
determining whether the attribute information satisfies an access condition in the matching rule information by the blockchain network, so as to return the authorization information of the data access request to the data provider.

7. The data access control method based on semantic support according to claim 1, wherein before acquiring fine-grained data corresponding to the data access request based on the data access mode of the ontology model, the method further comprises:
based on the ontology model, performing a data structure conversion on each distributed data source data to obtain standard distributed data source data;
determining a neighborhood concept and an inter-concept relationship of the standard distributed data source data based on the ontology model, so as to determine a mapping rule of the standard distributed data source based on the neighborhood concept and the inter-concept relationship; and
mapping the standard distributed data source and ontology knowledge of the standard distributed data source based on the mapping rule, so as to integrate each distributed data source data to obtain a virtual knowledge graph.

8. The data access control method based on semantic support according to claim 7, wherein acquiring fine-grained data corresponding to the data access request based on the data access mode of the ontology model, encrypting the fine-grained data, and sending the encrypted fine-grained data to the data access end, specifically comprises:
generating a query instruction corresponding to the data access request based on a preset query language;
calling a query interface of the virtual knowledge graph to send the query instruction to the virtual knowledge graph based on the query interface, acquiring data corresponding to the data access request based on the mapping of the virtual knowledge graph, and summarizing and generating fine-grained data; and
encrypting the fine-grained data based on a preset encryption method, so as to send the encrypted fine-grained data to the data access end based on the blockchain network.

9. A data access control device based on semantic support, wherein the device comprises:
a memory for storing computer program instructions and a processor for executing the program instructions, wherein when the computer program instructions can be executed by the processor, and the device is triggered to perform the method according to claim 1

10. A non-volatile computer storage medium, storing computer-executable instructions, wherein the computer-executable instructions are capable of: performing the method according to claim 1.
